(19) United States
(12) Patent Application Publication
(10) Pub. No.: US 2025/0023196 A1
(43) Pub. Date: Jan. 16, 2025

(54) ELECTROCHEMICAL DEVICE

(71) Applicant: Panasonic Intellectual Property Management Co., Ltd., Osaka (JP)

(72) Inventors: Shohei MASUDA, Hokkaido (JP); Kenichi NAGAMITSU, Kyoto Fu (JP); Nobuhiro SHIMAMURA, Osaka Fu (JP); Nobutaka TAKEDA, Osaka Fu (JP); Hideo SAKATA, Osaka Fu (JP)

(73) Assignee: Panasonic Intellectual Property Management Co., Ltd., Osaka (JP)

(21) Appl. No.: 18/686,257

(22) PCT Filed: Aug. 17, 2022
(86) PCT No.: PCT/JP2022/031067

§ 371 Date: Feb. 23, 2024

(30) Foreign Application Priority Data
Aug. 25, 2021 (JP) 2021-137453

(51) Int. Cl. H01M 50/489; H01M 4/02; H01M 4/583; H01M 10/0525; H01M 50/417

(52) U.S. Cl. CPC H01M 50/489; H01M 4/583; H01M 10/0525; H01M 50/417; H01M 2004/021; H01M 2004/027

(57) ABSTRACT

A disclosed electrochemical device includes a positive electrode, a negative electrode, an olefin-based separator, and a lithium ion-conductive electrolyte. The negative electrode includes a negative electrode current collector, and a negative electrode material layer supported on the negative electrode current collector. The negative electrode material layer includes a negative electrode active material into which lithium ions are reversibly doped. A surface layer portion of the negative electrode material layer has a film region, and when the film region is measured by X-ray photoelectron spectroscopy, a peak in an O1s spectrum is observed in a binding energy range of 530 to 534 eV. The peak intensity in the O1s spectrum increases from the surface layer of the film region to the inner side.

### TECHNICAL FIELD

The present disclosure relates to an electrochemical device.

### BACKGROUND ART

Electrochemical devices that use carbon material in which lithium ions are absorbed for negative electrode material layer are known (see Patent Literatures 1 to 3). An electrochemical device includes a positive electrode, a negative electrode and an electrolyte. As a lithium ion-conductive electrolyte, an electrolyte in which lithium salt such as LiPF₆ is dissolved in non-aqueous solvent is known.

Patent Literature 4 proposes a lithium ion capacitor that includes an electrolyte containing a mixture of lithium bis(fluorosulfonyl)imide (LiFSI) and LiBF₄, a solvent containing at least one type of cyclic or chain carbonate compound, and a film forming agent, wherein a molar ratio of LiFSI to LiBF₄ of 90/10 to 30/70, and the concentration of the mixture in the electrolyte is 1.2 to 1.8 mol/L.

### CITATION LIST

### Patent Literatures

PTL 1: JP 2014-123641A
PTL 2: Pamphlet of WO 2007/88604
PTL 3: Pamphlet of WO 2012/036249
PTL 4: JP 2017-216310A

### SUMMARY OF INVENTION

### Technical Problem

In electrochemical devices that use lithium ions, a solid electrolyte interface film (that is, SEI film) is formed on a negative electrode material layer during charging and discharging. The SEI film plays an important role in charge/discharge reactions, but if the SEI film is formed excessively thick, the internal resistance of the electrochemical device increases.

In electrochemical devices that use lithium ions, lithium ions are pre-doped in advance in the negative electrode prior to charging and discharging. Pre-doping is performed, for example, by immersing the negative electrode into an electrolyte containing lithium ions and applying a voltage to the negative electrode. In this case, the SEI film contains LiF as a main component. The SEI film containing LiF as a main component is stable to the electrolyte, but has a high resistance.

If an electrolyte in which a fluorine-containing phosphate such as LiPF₆ is dissolved is used, LiPF₆ is highly reactive with water and is easily decomposed. Due to the decomposition, HF is generated. The generated HF breaks down the SEI film. Therefore, a good-quality SEI film is difficult to be formed, and the internal resistance of the device tends to be high.

In contrast, if an electrolyte in which LiFSI is dissolved is used, LiFSI is difficult to react with water, and thus HF is not likely to be generated. However, an SEI film containing LiF as a main component is easily formed, and the internal resistance of the device becomes high.

### Solution to Problem

An aspect of the present invention relates to an electrochemical device including: a positive electrode, a negative electrode, a separator, and a lithium ion-conductive electrolyte, wherein the negative electrode includes a negative electrode current collector, and a negative electrode material layer supported on the negative electrode current collector, the negative electrode material layer includes a negative electrode active material into which lithium ions are reversibly doped, a surface layer portion of the negative electrode material layer has a film region, the separator includes an olefin-based resin, when the film region is measured by X-ray photoelectron spectroscopy, a peak in an O1s spectrum is observed in a binding energy range of 530 to 534 eV, and an intensity of the peak in the O1s spectrum increases from a surface layer of the film region toward an inner side.

### Advantageous Effects of Invention

According to the present invention, an increase in the internal resistance of an electrochemical device is suppressed.

### BRIEF DESCRIPTION OF DRAWINGS

FIG. 1 is a vertical cross-sectional view illustrating a configuration of an electrochemical device according to an embodiment of the present invention.

FIG. 2 is a graph of results of XPS analysis of a film region formed so that a first layer containing lithium fluoride covers a second layer containing lithium carbonate, illustrating a peak intensity A at the top of the peak attributed to binding of lithium carbonate in the O1s spectrum, a peak intensity B at the top of the peak in the F1s spectrum, and changes in the peak intensity ratio A/B in the depth direction of the film region.

FIG. 3 is a graph of results of XPS analysis of the film region in which the second layer containing lithium carbonate is not covered by the first layer containing lithium fluoride, illustrating the peak intensity A at the top of the peak attributed to binding of lithium carbonate in the O1s spectrum, the peak intensity B at the top of the peak in the F1s spectrum, and changes in the peak intensity ratio A/B in the depth direction of the film region.

### DESCRIPTION OF EMBODIMENTS

An electrochemical device according to an embodiment of the present invention includes a positive electrode, a negative electrode, and a lithium ion-conductive electrolyte. Commonly, the positive electrode and the negative electrode, together with a separator interposed therebetween, constitute an electrode assembly. The electrode assembly is configured, for example, as a columnar wound body obtained by winding the band-shaped positive and negative electrodes via the separator. Also, the electrode assembly may also be configured as a laminated body obtained by laminating plate-shaped positive and negative electrodes one above the other via the separator. The separator includes an olefin-based resin.

The negative electrode includes a negative electrode current collector, and a negative electrode material layer supported on the negative electrode current collector. The negative electrode material layer includes a negative electrode active material into which lithium ions are reversibly doped. The negative electrode includes a carbon material.

The carbon material experiences a Faraday reaction in which lithium ions are reversibly absorbed and released, and capacitance is generated. Doping of lithium ions into the negative electrode active material includes at least a phenomenon in which lithium ions are absorbed into the negative electrode active material, and is a concept that may also include adsorption of lithium ions to the negative electrode active material, chemical interaction between the negative electrode active material and lithium ions, and the like.

The surface layer portion of the negative electrode material layer has a film region. The film region is a region in which the SEI film is formed. The SEI film contains lithium carbonate (Li₂CO₃). The SEI film containing lithium carbonate has a low resistance to lithium ion movement, and by forming the SEI film containing lithium carbonate as a main component, it is possible to reduce the internal resistance of the electrochemical device. On the other hand, the SEI film containing lithium carbonate as a main component easily reacts with HF generated by decomposition reaction of the electrolyte, and the SEI film is easily broken down.

The SEI film may also contain lithium fluoride (LiF). Such a SEI film containing lithium fluoride is stable to an electrolyte and is poorly-reactive with HE However, the SEI film containing lithium fluoride as a main component has a high resistance to lithium ion movement, and the internal resistance of the electrochemical device is likely to increase.

When the film region containing lithium carbonate is measured by X-ray photoelectron spectroscopy (XPS), a peak attributed to binding of lithium carbonate is observed in the O1s spectrum. The peak attributed to binding of lithium carbonate is a peak attributed to a C═O (or C—O) bond of lithium carbonate, and can appear in a binding energy range of 530 to 534 eV.

On the other hand, when the film region containing lithium fluoride is measured by X-ray photoelectron spectroscopy (XPS), a peak attributed to binding of lithium fluoride is observed in the F1s spectrum. The peak attributed to binding of lithium carbonate is a peak attributed to an Li—F bond, and can appear in a binding energy range of 684.8 to 685.3 eV.

In the electrochemical device according to an embodiment of the present invention, in the O1s spectrum, the intensity of the peak observed in the binding energy range of 530 to 534 eV increases from the surface layer of the film region toward the inner side. This means that lithium carbonate is unevenly distributed in the depth direction in a manner such that in the film region, a large amount of lithium carbonate exists in the center and deep portions of the film region (on the negative electrode active material side), and the amount of lithium carbonate existing in the surface layer of the film region is reduced. With this, the SEI film containing a large amount of lithium carbonate is restricted from coming into contact with the electrolyte and the breakdown of the SEI film is suppressed, while keeping the resistance to lithium ion movement low. Note that it is sufficient that the intensity of the peak observed in the binding energy range of 530 to 534 eV increases from the surface layer of the film region to a position at any depth toward the inner side. For example, the intensity of the peak observed in the binding energy range of 530 to 534 eV may increase and then decrease from the surface layer of the film region toward the inner side.

In contrast, in the F1s spectrum, the intensity of the peak observed in a binding energy range of 684.8 to 685.3 eV may decrease from the surface layer of the film region toward the inner side, in the above-described depth region where the intensity of the peak attributed to binding of lithium carbonate in the O1s spectrum increases from the surface layer of the film region toward the inner side. That is to say, an SEI film containing a large amount of lithium fluoride may be formed on the surface layer of the film region that is in contact with the electrolyte. The SEI film containing a large amount of lithium fluoride is stable to the electrolyte, and the SEI film is difficult to be broken down. Also, the SEI film containing a large amount of lithium carbonate is formed inside, and thus it is sufficient for the SEI film containing a large amount of lithium fluoride to have a small thickness, resulting in a suppression in the resistance to the lithium ion movement.

In other words, the film region includes a first layer that is formed on the surface layer in contact with the electrolyte and contains a large amount of lithium fluoride, and a second layer that is formed on the inner side relative to the first layer (on the side in contact with the negative electrode active material) and contains a larger amount of lithium carbonate. The concentration of lithium fluoride (content per unit volume) in the first layer is larger than the concentration of lithium fluoride in the second layer. On the other hand, the concentration of lithium carbonate (content per unit volume) in the second layer is larger than the concentration of lithium carbonate in the first layer. However, there is no need to have a clear difference in the concentration of lithium carbonate or lithium fluoride between the first and second layers across the boundary thereof, and the concentration of lithium fluoride may gradually decrease from the first layer to the second layer, and/or the concentration of lithium carbonate may gradually increase from the first layer to the second layer.

At any depth, the peak intensity at the top of the above-described peak in the O1s spectrum is defined as peak intensity A, and the peak intensity at the top of the above-described peak in the F1s spectrum is defined as peak intensity B. The distribution of peak intensities B in the depth direction (thickness direction of the surface layer portion) can have the top, which is the maximum peak intensity, in the surface layer (first layer) of the film region. In contrast, the distribution of peak intensities A in the depth direction (in the thickness direction of the surface layer portion) is such that the peak intensity in the surface layer of the film region increases toward the negative electrode active material, and can have the top, which is the maximum peak intensity, in the second layer located on the inner side (negative electrode active material side) relative to the surface layer. In this case, the peak intensity ratio A/B increases and then decreases from the surface layer of the film region to the inner side. It is preferable that the peak intensity ratio A/B have a maximum value within the film region. In this case, when the surface layer portion of the negative electrode material layer is measured by X-ray photoelectron spectroscopy, at the position in the depth direction at which the peak intensity ratio A/B is the maximum, substantially no peak attributed to a carbon material is observed in the C1s spectrum.

The peak attributed to the carbon material in the C1s spectrum is a peak attributed to a C—C bond in the plane of graphite, and may appear in the binding energy range of 281 to 283 eV. The expression “substantially no peak attributed to a carbon material is observed” means that the peak intensity at the top of the above-described peak is 0.2 times or less as large as the peak intensity A.

The maximum value of the peak intensity ratio A/B in the depth direction is, for example, 0.5 or more and 2 or less, and may be 1 or more and 1.8 or less. The peak intensities A and B are obtained based on the height of the peaks from the baseline.

The layer (second layer) containing a large amount of lithium carbonate may be formed in the surface layer portion of the negative electrode material layer before assembling the electrochemical device. In the electrochemical device assembled using this negative electrode, through subsequent charging and discharging, the first layer containing a large amount of lithium fluoride may be formed on the surface of the negative electrode active material with a homogeneous and appropriate thickness, with the second layer serving as an underlying layer. The first layer is formed as a result of, for example, a reaction between the electrolyte and the negative electrode in the electrochemical device. The second layer containing lithium carbonate acts to promote the formation of the first layer, which is a good SEI film, and to maintain the SEI film in good conditions when charging and discharging are repeatedly performed.

However, the negative electrode on which the second layer containing lithium carbonate is formed is likely to be subjected to performance degradation due to a deterioration of the separator. The conceivable reason is that, during the formation of the first layer or pre-doping, metallic lithium reacts with the separator and the separator is easily damaged. In particular, cellulose-based separators conventionally and commonly used have many functional groups that easily react with lithium ions, such as OH groups, and also contain a relatively large amount of water, and thus are easily to be subjected to damage due to side reactions. Also, due to the reaction of metallic lithium with the separator, the amount of lithium pre-doped in the negative electrode may be reduced. The main reason why cellulose-based separators are commonly used is that they have excellent electrolyte permeability and pre-doping proceed easily.

The formation of the first layer is performed by bringing, the negative electrode material layer in which the second layer is formed on the surface layer portion, into contact with the electrolyte, as will be described below. The formation of the second layer can be formed by a vapor phase method, application method, or by depositing metallic lithium on the surface of the negative electrode material layer and then exposing it to carbon dioxide atmosphere, as will be described below. In particular, when the second layer is formed using the latter method, bringing the negative electrode material layer for the negative electrode of a wound body in which the positive and negative electrodes are wound via the separator into contact with the electrolyte may cause the separator to be damaged during the formation of the first layer.

When performing pre-doping of lithium ions in the state of the wound body, it is difficult to use an olefin separator because the lithium ions eluted from the metallic lithium fed for pre-doping are difficult to be diffused over the entire wound body. So, when metallic lithium for pre-doping is directly immersed into the electrolyte, it is essential to use a cellulose-based separator.

In contrast, in the electrochemical device according to the present embodiment, a separator containing an olefin-based resin (olefin-based separator) is used. Since olefin-based separators have low reactivity with metallic lithium, the use of a separators containing an olefin-based resin suppresses the deterioration of the separator and improves the reliability of the electrochemical device. In addition, olefin-based separators have high strength and can have a sufficiently high strength even if it is made thin. Therefore, by tightly winding the positive electrode and the negative electrode, it is possible to use a wound body with high surface pressure, resulting in an improvement in the performance of electrochemical devices, such as capacity.

The olefin-based resin contained in the separator preferably includes at least one selected from the group consisting of polypropylene (PP) and polyethylene (PE). The PP separator and the PE separator have high strength and are stable against an electrolyte containing lithium ions, and thus can be preferably used in the electrochemical device in which the first layer and the second layer are formed on the surface layer portion of the negative electrode material layer.

With the description above, according to the electrochemical device of the present embodiment, by forming a film containing lithium carbonate on the surface layer portion of the negative electrode material layer, the resistance to the lithium ion movement can be reduced and the internal resistance of the electrochemical device can be reduced. Also, the use of a separator containing an olefin-based resin can suppress the deterioration of the separator, and maintain a state in which the internal resistance is low for a long period of time, thereby improving reliability.

On the other hand, olefin-based separators have a higher air permeability resistance than cellulose-based separators, and have a low passage rate of lithium ions via the separator. Such a large air permeability resistance of olefin-based separators does not pose any problem in charging and discharging of normal electrochemical devices, but in the process of pre-doping lithium ions, pre-doping may take time due to the low passage rate of lithium ions. In this regard, in the pre-doping process, it is preferable to adopt a method in which lithium ions are not supplied to the negative electrode via the separator. For example, as described below, pre-doping can be executed without requiring a long time by bringing the negative electrode with metallic lithium attached to the entire surface of the negative electrode material layer in advance, into contact with the electrolyte.

The air permeability resistance A of the separator is preferably 70 sec/100 mL or more and 500 sec/100 mL or less. When the air permeability resistance A is in this range, it is possible to realize both a reduction in the internal resistance of the electrochemical device and an improvement in the reliability. More preferably, the air permeability resistance A of the separator may be 70 sec/100 mL or more and 300 sec/100 mL or less, 70 sec/100 mL or more and 230 sec/100 mL or less, or 180 sec/100 mL or more and 230 sec/100 mL or less.

The air permeability resistance A is an index indicating the time (in seconds) required for a given volume (100 mL) of air to permeate per unit area of the separator when a given pressure difference is applied between two sides of the separator, and is measured based on JIS P8117:2009 by the Gurley tester method in which the separator area (permeable portion) is set to 6.42 cm² and the weight of the inner cylinder is set to 567 g.

The thickness of the separator is preferably 12 μm or more and 30 μm or less, in view of that lithium ions can easily permeate and the separator has a sufficient strength.

The thickness of the first layer containing a large amount of lithium fluoride needs only be, for example, 1 nm or more, or 3 nm or more, or it is sufficient that the thickness is 5 nm or more. However, if the thickness of the first layer exceeds 20 nm, the first layer itself can become a resistance component. Accordingly, the thickness of the first layer may be 20 nm or less, or may be 10 nm or less.

In contrast, the thickness of the second layer containing a large amount of lithium carbonate needs only be, for example, 1 nm or more, and needs only be 5 nm if expecting more long-term effects, and needs only be 10 nm if expecting more reliable effects. However, if the thickness of the second layer exceeds 50 nm, the first layer itself may become a resistance component. Accordingly, the thickness of the second layer may be 50 nm or less, or may be 30 nm or less. For example, the thickness of the second layer is 1 nm to 50 nm.

The thickness of the film region (thicknesses of the first layer and the second layer) is (are) measured by analyzing the surface layer portion of the negative electrode material layer at a plurality of positions (at least 5 positions) of the negative electrode material layer. It is sufficient that an average of the thicknesses of the first layer or the second layer obtained at the plurality of positions is used as the thickness of the first layer or the second layer. The negative electrode material layer to be used as the measurement sample may be stripped off from the negative electrode current collector. In this case, it is sufficient to analyze the film formed on the surface of the carbon material that constitutes the vicinity of the surface layer portion of the negative electrode material layer. In this case, it is sufficient to sample, from the region of the negative electrode material layer disposed on the side opposite to the side bonded to the negative electrode current collector, the carbon material covered with the film, and use the sampled carbon material for the analysis.

In the case of the negative electrode taken out from the inside of the electrochemical device that has been completed and has undergone a predetermined aging or at least one charging and discharging cycle, the film formed on the surface layer portion of the negative electrode material layer or on the surface of the carbon material has an SEI film (that is, the first layer) formed in the electrochemical device. In this case, in the O1s spectrum, a peak attributed to lithium carbonate may be observed also in the first layer. However, the first layer generated in the electrochemical device has a different composition than the second layer that was formed in advance before assembling the electrochemical device, and thus the two layers are distinguishable. For example, in the XPS analysis of the first layer, an F1s peak attributed to an LiF bond is observed, but in the second layer, no substantial F1s peak attributed to an LiF bond is observed. Also, the amount of lithium carbonate contained in the first layer is very small. Note that as a peak in an Li1s spectrum, for example, a peak derived from a compound such as ROCO₂Li or ROLi can be detected.

When the film region containing lithium carbonate is analyzed by XPS, in the O1s spectrum, as well as a peak (first peak) attributed to a C═O bond, a peak (second peak) attributed to a Li—O bond may be observed. The region of the film located in the vicinity of the surface of the carbon material is considered to contain a small amount of LiOH or Li₂O.

Specifically, when analyzing the film region in the depth direction, in the O1s spectrum, a first region where the first peak (attributed to a C═O bond) and the second peak (attributed to an Li—O bond) are observed, and the first peak intensity is greater than the second peak intensity, and a second region where the first peak and the second peak are observed, and the second peak intensity is greater than the first peak intensity may be observed. The first region has the closer distance to the outermost surface of the surface layer portion than the second region. Also, there may additionally be a third region that is closer to the outermost surface of the surface layer portion than the first region and in which the first peak is observed but the second peak is not observed. The third region is likely to be observed when the thickness of the second layer is large.

Typically, in the center of the second layer in the thickness direction, substantially no peak attributed to the C—C bond in the C1s spectrum is observed, or even if any peak is observed, the peak attributed to the C—C bond is one half or less of the intensity of a peak attributed to the C═O bond.

In the XPS analysis performed on the surface layer portion of the negative electrode material layer, for example, the film formed on the surface layer portion or the surface of the carbon material is irradiated with an argon beam in the chamber of an X-ray photoelectron spectrometer, and changes in each spectrum attributed to C1s, O1s or F1s electrons with respect to irradiation time are observed and recorded. In this case, the spectrum of the outermost surface of the surface layer portion may be disregarded from the viewpoint of avoiding an analysis error. The thickness of the region where the peak attributed to lithium fluoride is stably observed corresponds to the thickness of the first layer. The thickness of the region where the peak attributed to lithium carbonate is stably observed corresponds to the thickness of the second layer.

The following will describe a method of forming the film region in the surface layer portion of the negative electrode material layer. First, a second layer containing lithium carbonate is formed in the surface layer portion of the negative electrode material layer. The process of forming the second layer can be performed by, for example, a vapor phase method, application method, transfer, or the like.

Examples of the vapor phase methods include chemical vapor deposition, physical vapor deposition, and sputtering. For example, lithium carbonate needs only be attached to the surface of the negative electrode material layer using a vacuum vapor deposition apparatus. It is sufficient that the pressure in the apparatus chamber during the vapor deposition is, for example, 10⁻² to 10⁻⁵ Pa, the temperature of the lithium carbonate vapor source is 400 to 600° C., and the temperature of the negative electrode material layer is −20 to 80° C.

As the application method, the solution or dispersion containing lithium carbonate can be applied to the surface of the negative electrode using, for example, a micro-gravure coater and dried to form the second layer. The lithium carbonate content in the solution or dispersion is, for example, 0.3 to 2% by mass, and if a solution is used, it is sufficient to use the solution having a concentration less than or equal to the solubility (for example, 0.9 to 1.3% by mass for aqueous solution at room temperature).

Furthermore, by performing a process of forming a first layer containing lithium fluoride to cover at least part of the second layer, the negative electrode can be obtained. The surface layer portion of the obtained negative electrode material layer has a first layer and a second layer. The first layer is formed so that at least part of the first layer covers at least part (preferably the whole) of the surface of the negative electrode active material via the second layer (i.e., using the second layer as abase layer).

The process of forming the first layer is performed in a state in which the negative electrode material layer is in contact with the electrolyte, and thus may also serve as at least part of the process of pre-doping lithium ions into the negative electrode material layer. For example, metallic lithium can be used as a source of lithium ions to be pre-doped.

The metallic lithium may be attached to the surface of the negative electrode material layer. Note that by exposing the negative electrode having the negative electrode material layer to which metallic lithium is attached to a carbon dioxide atmosphere, it is also possible to form, for example, a second layer containing lithium carbonate with a thickness of 1 nm or more and 50 nm or less.

The process of attaching metallic lithium to the surface of the negative electrode material layer can be performed, for example, by a vapor phase method, transfer, or the like. Examples of the vapor phase methods include chemical vapor deposition, physical vapor deposition, and sputtering. For example, it is sufficient to form metallic lithium in the shape of a film on the surface of the negative electrode material layer using a vacuum vapor deposition apparatus. It is sufficient that the pressure in the apparatus chamber during the vapor deposition is, for example, 10⁻² to 10⁻⁵ Pa, the temperature of the lithium vapor sources is 400 to 600° C., and the temperature of the negative-electrode mixture layer is −20 to 80° C.

It is desirable that the carbon dioxide atmosphere is an atmosphere that is dry and free of moisture, and the carbon dioxide atmosphere may have, for example, a dew-point temperature of −40° C. or less, or −50° C. or less. The carbon dioxide atmosphere may contain gases other than carbon dioxide, but the molar fraction of carbon dioxide is preferably 80% or more, and more preferably 95% or more. It is desirable that oxidized gases be not included, and the mole fraction of oxygen may be 0.1% or less.

To form a thicker second layer, it is efficient that the partial pressure of carbon dioxide is greater than, for example, 0.5 atmospheric pressure (5.05×10⁴ Pa), and may be 1 atmospheric pressure (1.01×10⁵ Pa) or more.

The temperature of the negative electrode exposed to the carbon dioxide atmosphere may be in a range of 15° C. to 120° C., for example. The higher the temperature is, the thicker the second layer is.

By changing the time for which the negative electrode is exposed to the carbon dioxide atmosphere, it is possible to easily control the thickness of the second layer. The exposure time may be, for example, 12 hours or more, and less than 10 days.

It is desirable that the process of forming the second layer is performed before assembling an electrode assembly, but a case where the process of forming the second layer is performed after assembling the electrode assembly is not eliminated. That is to say, the second layer may also be formed in the surface layer portion of the negative electrode material layer, by preparing a positive electrode, preparing a negative electrode including a negative electrode material layer to which metallic lithium is attached, forming an electrode assembly in which a separator interposed between the positive electrode and the negative electrode, and exposing the electrode assembly to a carbon dioxide atmosphere.

Note that the process of pre-doping lithium ions into the negative electrode material layer can further progress by, for example, bringing the negative electrode material layer with the electrolyte thereafter, and the process is completed when the negative electrode material layer being in contact with the electrolyte is left for a predetermined time. Such a process may be a process of forming a first layer so that it covers at least part of the second layer. For example, by performing at least one charging and discharging cycle on the electrochemical device, it is possible to form the first layer on the negative electrode material layer and complete pre-doping of lithium ions into the negative electrode. The pre-doping of lithium ions into the negative electrode can also be completed, for example, by applying a predetermined charging voltage (e.g., 3.4 to 4.0 V) between the terminals of the positive and negative electrodes for a predetermined time (e.g., 1 to 75 hours).

The electrochemical device according to the present invention encompasses electrochemical devices such as lithium ion secondary batteries, lithium ion capacitors, and electric double layer capacitors. As the positive electrode of the electrochemical device, for example, a polarizable electrode layer may be configured using a positive electrode material layer including a carbon material as a positive electrode active material. In this case, an electric double layer is formed by adsorption of ions to the positive electrode active material, and capacitance is generated on the positive electrode side. The carbon material may be, for example, activated carbon. The carbon material (for example, activated carbon) may preferably have a specific surface area of 1500 m²/g or more and 2500 m²/g or less, an average particle diameter of 10 μm or less, a total pore volume of 0.5 cm³/g or more and 1.5 cm³/g or less, and an average pore size of 1 nm or more and 3 nm or less.

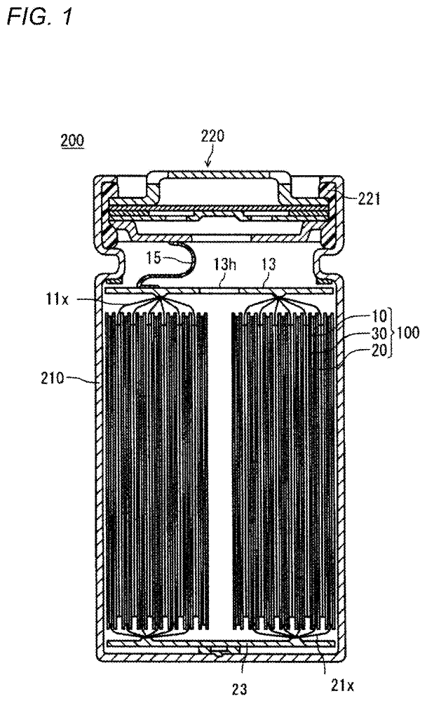

FIG. 1 schematically shows a configuration of an electrochemical device 200 according to an embodiment of the present invention. The electrochemical device 200 includes an electrode assembly 100, a non-aqueous electrolyte (not shown), a bottomed cell case 210 that is made of a metal and houses the electrode assembly 100 and the non-aqueous electrolyte, and a sealing plate 220 that seals an opening in the cell case 210. The sealing plate 220 has a gasket 221 attached to the peripheral edge thereof, and the open end of the cell case 210 is fitted to the gasket 221, so that the inside of the cell case 210 is sealed. A positive electrode current collecting plate 13 having a through hole 13h in the center thereof is welded to ore material exposed portions 11x for positive electrodes. A tab lead 15 has one end connected to the positive electrode current collecting plate 13, and the other end connected to the inner surface of the sealing plate 220. Accordingly, the sealing plate 220 functions as an external positive electrode terminal. On the other hand, a negative electrode current collecting plate 23 is welded to core material exposed portions 21x for negative electrodes. The negative electrode current collecting plate 23 is directly welded to a welding member provided on the inner bottom surface of the cell case 210. Thus, the cell case 210 functions as an external anode terminal.

Hereinafter, the constituent components of the electrochemical device according to the embodiment of the present invention will be described in further detail.

### (Negative Electrode)

The negative electrode includes a negative electrode current collector, and a negative electrode material layer (negative electrode mixture layer) supported on the negative electrode current collector.

A sheet-shaped metal material is used for the negative electrode current collector. The sheet-shaped metal material may be metal foil, porous metal, etched metal, or the like. The metal material may be copper, a copper alloy, nickel, stainless steel, or the like.

The negative electrode current collecting plate is a metal plate in a substantially disk shape. Examples of the material of the negative electrode current collecting plate include copper, a copper alloy, nickel, and stainless steel. The material of the negative electrode current collecting plate may be the same as the material of the negative electrode current collector.

### (Negative Electrode Material Layer)

The negative electrode material layer includes, as the negative electrode active material, a carbon material that electrochemically absorbs and releases lithium ions. The carbon material is preferably graphite, non-graphitizable carbon (hard carbon), or graphitizable carbon (soft carbon) are preferable, and graphite and hard carbon are particularly preferable. It is also possible to use a carbon material and another material in parallel.

The non-graphitizable carbon may have an interplanar spacing of planes (002) (i.e., interplanar spacing between carbon layers) d₀₀₂ of 3.8 Å or more, as measured by the X-ray diffraction method. It is desirable that the theoretical capacity of the non-graphitizable carbon be, for example, 150 mAh/g or more. By using such non-graphitizable carbon, it is easier to obtain a negative electrode that has a small low-temperature DCR and small expansion and contraction during charging and discharging. The non-graphitizable carbon accounts for preferably 50% or more, more preferably 80% or more, and furthermore preferably 95% or more by mass of the negative electrode active material. Also, the non-graphitizable carbon accounts for preferably 40% or more, more preferably 70% or more, and furthermore preferably 90% or more by mass of the negative-electrode mixture layer.

As the negative electrode active material, such non-graphitizable carbon and a material other than the non-graphitizable carbon may be used in parallel. Examples of the material other than the non-graphitizable carbon that can be used as the negative electrode active material include graphitizable carbon (soft carbon), graphite (such as natural graphite and artificial graphite), lithium titanium oxide (such as spinel-type lithium titanium oxide), silicon oxide, a silicon alloy, tin oxide, and a tin alloy.

From the viewpoint of high fillability of the negative electrode with the negative electrode active material and easy controllability of side reactions with the electrolyte, the average particle diameter of the negative electrode active material (particularly, non-graphitizable carbon) is preferably 1 μm to 20 μm, and is more preferably 2 μm to 15 μm.

Note that in the present specification, the average particle diameter means the median diameter (D₅₀) on a volumetric basis in a particle size distribution obtained by laser diffraction particle size distribution measurement.

The negative electrode material layer contains the negative electrode active material as an essential component and contains a conductive material and a binding material as optional components. The conductive material includes carbon black, carbon fiber, and the like. The binding material includes a fluorocarbon resin, an acrylic resin, a rubber material, a cellulose derivative, and the like.

The negative electrode material layer is formed by, for example, mixing the negative electrode active material, a conductive agent, and a binding agent with a dispersion medium to prepare a negative electrode mixture slurry, applying the negative electrode mixture slurry to the negative electrode current collector, and then drying it. The thickness of the negative electrode material layer is, for example, 10 to 300 μm per side.

The negative electrode material layer is pre-doped with lithium ions in advance. With this, the potential of the negative electrode decreases, and thus the potential difference (that is, a voltage) between the positive electrode and the negative electrode increases, resulting in an improvement in the energy density of the electrochemical device. The amount of lithium pre-doped may be about, for example, 50% to 95% of the maximum amount of lithium that can be absorbed in the negative electrode material layer.

### (Positive Electrode)

The positive electrode includes a positive electrode current collector, and a positive electrode material layer (positive electrode mixture layer) supported on the positive electrode current collector.

A sheet-shaped metal material is used for the positive electrode current collector. The sheet-shaped metal material may be metal foil, porous metal, etched metal, or the like. The metal material may be aluminum, an aluminum alloy, nickel, titanium, or the like.

The positive electrode current collecting plate is a metal plate in a substantially disk shape. A through hole serving as a pathway for a non-aqueous electrolyte is preferably formed in the center of the positive electrode current collecting plate. Examples of the material of the positive electrode current collecting plate include aluminum, an aluminum alloy, titanium, and stainless steel. The material of the positive electrode current collecting plate may be the same as the material of the positive electrode current collector.

### (Positive Electrode Material Layer)

The positive electrode material layer contains, as the positive electrode active material, a material that reversibly dopes anions. The positive electrode active material is, for example, a carbon material, conductive polymers, or the like.

As a carbon material used as the positive electrode active material, a porous carbon material is preferably used, and, for example, activated carbon and a carbon material (for example, non-graphitizable carbon) exemplified as the negative electrode active material are preferable. Examples of a raw material of the activated carbon include wood, palm shells, coal, pitch, and phenolic resin. The activated carbon is preferably carbon subjected to activation process.

The average particle diameter (median diameter D50 on a volumetric basis) of the carbon material is not particularly limited, but is preferably 20 μm or less, and more preferably 10 μm or less. The average particle diameter of the carbon material may be 3 μm to 10 μm.

The specific surface area of the positive electrode material layer typically reflects the specific surface area of the positive electrode active material. The specific surface area of the positive electrode material layer may be, for example, 600 m²/g or more and 4000 m²/g or less, and may preferably be 800 m²/g or more and 3000 m²/g or less. More preferably, the specific surface area of the positive electrode material layer may be 1500 m²/g or more and 2500 m²/g or less.

The specific surface area of the positive electrode mixture layer is a BET specific surface area obtained using a measurement device in accordance with JIS Z8830 (for example, TriStar II 3020 of Shimadzu Corporation). Specifically, the electrochemical device is disassembled and the positive electrode is extracted. Then, the positive electrode is washed with dimethyl carbonate (DMC) and dried. Subsequently, the positive electrode mixture layer is stripped from the positive electrode current collector, and a sample of about 0.5 g of the positive electrode mixture layer is collected.

Then, the collected sample is heated at 150° C. for 12 hours under a reduced pressure of 95 kPa or less, and then nitrogen gas is adsorbed on the sample of known mass to obtain an adsorption isotherm in the range of relative pressure of 0 to 1. The surface area of the sample is calculated based on the amount of monolayer adsorption of gas obtained from the adsorption isotherm. Here, the specific surface area is obtained from the following BET expression of the BET single point method (relative pressure of 0.3).

$$\\ \begin{matrix}P / V ( P 0 - P ) = ( 1 / VmC ) + \{ ( C - 1 ) / VmC \} ( P / P 0 ) & ( 1 )\end{matrix}$$

$$\\ \begin{matrix}S = kVm & ( 2 )\end{matrix}$$

P0: Saturation vapor pressure
P: Adsorption equilibrium pressure
V: Amount of adsorption at adsorption equilibrium pressure P
Vm: Amount of monolayer adsorption
C: Parameter relating to adsorption heat
S: Specific surface area
k: Unimolecular area at nitrogen, 0.162 nm²

The activated carbon accounts for preferably 50% or more, more preferably 80% or more, and furthermore preferably 95% or more by mass of the positive electrode active material. Also, the activated carbon accounts for preferably 40% or more, more preferably 70% or more, and furthermore preferably 90% or more by mass of the positive electrode mixture layer.

The positive electrode material layer contains the positive electrode active material as an essential component and contains a conductive material and a binding material as optional components. The conductive material includes carbon black, carbon fiber, and the like. The binding material includes a fluorocarbon resin, an acrylic resin, a rubber material, a cellulose derivative, and the like.

The positive electrode material layer is formed by, for example, mixing the positive electrode active material, a conductive agent, and a binding agent with a dispersion medium to prepare a positive electrode mixture slurry, applying the positive electrode mixture slurry to the positive electrode current collector, and then drying the resultant. The thickness of the positive electrode material layer is, for example, 10 to 300 μm per side.

The conductive polymer used as the positive electrode active material is preferably a π-conjugated polymer. As the π-conjugated polymer, for example, polypyrrole, polythiophene, polyfuran, polyaniline, polythiophenevinylene, polypyridine, or their derivatives can be used. These may be used alone or in combination of two or more. The weight average molecular weight of the conductive polymers is, for example, 1000 to 100000. Note that derivatives of the π-conjugated polymer mean polymers having a basic skeleton of the π-conjugated polymer such as polypyrrole, polythiophene, polyfuran, polyaniline, polythiophenevinylene, and polypyridine. For example, polythiophene derivatives include poly(3,4-ethylenedioxythiophene) (PEDOT), and the like.

The conductive polymers are formed by, for example, immersing a positive electrode current collector with a carbon layer into a reaction solution containing monomers of a raw material for the conductive polymers, and electropolymerizing the raw material monomers in the presence of the positive electrode current collector. In the electropolymerization, it is sufficient that the positive electrode current collector and the counter electrode are immersed into the reaction solution containing the raw material monomers, and a current is caused to flow between the positive electrode current collector serving as an anode, and the counter electrode. The conductive polymers may also be formed by a method other than electropolymerization. For example, the conductive polymers may be formed by chemical polymerization of the raw material monomers. In the chemical polymerization, it is sufficient that the raw monomers are polymerized by an oxidizing agent or the like in the presence of the positive electrode current collector.

The raw material monomers used in the electropolymerization or chemical polymerization may be any polymerizable compound as long as it can generate conductive polymers by polymerization. The raw material monomers may include oligomers. For example, aniline, pyrrole, thiophene, furan, thiophenevinylene, pyridine, or their derivatives are used as the raw material monomers. These may be used alone or in combination of two or more. Among them, aniline is easily grown on the surface of the carbon layer by electropolymerization.

The electropolymerization or chemical polymerization can be performed using a reaction solution containing anions (dopants). Doping the π-electron conjugated polymers with dopants achieves excellent conductive properties. Dopants include sulfate ions, nitrate ions, phosphate ions, borate ions, benzenesulfonate ions, naphthalenesulfonate ions, toluenesulfonate ions, methanesulfonate ions, perchlorate ions, tetrafluoroborate ions, hexafluorophosphate ions, fluorosulfate ions, and the like. The dopants may also be polymer ions. Examples of polymer ions include ions of polyvinyl sulfonate, polystyrene sulfonate, polyaryl sulfonate, polyacryl sulfonate, polymethacryl sulfonate, poly(2-acrylamido-2-methylpropanesulfonate), polyisoprene sulfonate, polyacrylic acid, and the like.

### (Separator)

The separator includes an olefin-based resin. The olefin-based resin is a resin that contains an olefin unit as a main component. The olefin-based resin contains, for example, 50% or more, and furthermore 70% or more by mass of the olefin unit. An olefin unit refers to a monomer unit derived from olefin (alkene) such as ethylene, propylene, and butene. Here, the divalent group (diyl group) formed by polymerization of a monomer is referred to as the “unit” of that monomer. At least part of the olefin may be derivatives thereof. The olefin-based resin may be a homopolymer or a copolymer synthesized from a plurality of types of olefins. Part of the hydrogen atoms of the olefin may be substituted with halogen atoms. Examples of the olefin-based resin may include polyethylene (PE), polypropylene (PP), polymethylpentene (PMP), chlorinated polyethylene (CPE), ethylene-vinyl acetate copolymer (EVA), and ethylene-ethyl acrylate copolymer (EEA).

The separator containing an olefin-based resin may be, for example, a microporous membrane, woven or non-woven fabric made of polyolefin. The thickness of the separator is, for example, 8 to 40 μm, is preferably 12 to 30 μm, and more preferably 14 to 25 μm or 16 to 25 μm. Among microporous membranes, woven fabrics, and non-woven fabrics, microporous membranes, which are non-fibrous porous films, are preferable in view of their particularly high strength and suitability for film thinning.

### (Electrolyte)

The electrolyte has lithium ion conductivity, and contains lithium salt and a solvent in which lithium salt is dissolved. Anions of lithium salt reversibly repeat doping to and dedoping from the positive electrode. Lithium ions derived from lithium salt are reversibly absorbed and released to the negative electrode.

Examples of lithium salt include LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(SO₂F)₂, and LiN(SO₂CF₃)₂. These may be used alone or in combination of two or more. Lithium salt is preferably salt having fluorine-containing anions in view of its abilities to obtain electrolyte with high dissociation and low viscosity, and improve the voltage withstanding characteristics of the electrochemical device.

The electrolyte preferably includes an imide-based electrolyte. The imide-based electrolyte contains imide-based anions as anions of the lithium salt. The imide-based anions may be anions containing fluorine and sulfur, and may particularly preferably be lithium bis(fluorosulfonyl)imide, that is, LiN(SO₂F)₂(LiFSI). For example, 80% or more by mass of the lithium salt may be LiFSI.

It is conceivable that LiFSI has the effect of reducing degradation of the positive electrode active material and the negative electrode active material. Among salts with fluorine-containing anions, FSI anions have excellent stability, and thus are considered to be less likely to produce side products and contribute to smooth charging and discharging without damaging the surface of the active material. The SET film formed of LiFSI on the surface layer portion of the negative electrode material layer contains a large amount of lithium fluoride and a small percentage of lithium carbonate. With this, a stable film (first layer), which contains lithium fluoride as a main component, can be formed so as to cover the second layer, which contains lithium carbonate as a main component.

The concentration of the lithium salt in the non-aqueous electrolyte in a charged state (at a state of charge (SOC) of 90 to 100%) is, for example, 0.2 to 5 mol/L.

As the solvent, the following can be used. That is, cyclic carbonates such as ethylene carbonate, propylene carbonate, and butylene carbonate; chain carbonates such as dimethyl carbonate, diethyl carbonate, and ethyl methyl carbonate; aliphatic carboxylic acid esters such as methyl formate, methyl acetate, methyl propionate, ethyl propionate; lactones such as γ-butyrolactone and γ-valerolactone; chain ethers such as 1,2-dimethoxyethane (DME), 1,2-diethoxyethane (DEE), and ethoxymethoxyethane (EME); cyclic ethers such as tetrahydrofuran, and 2-methyltetrahydrofuran; dimethyl sulfoxide; 1,3-dioxolane; formamide; acetamide; dimethylformamide; dioxolane; acetonitnile; propionitrile; nitromethane; ethyl monoglyme; trimethoxymethane; sulfolane; methylsulfolane; 1,3-propanesartone; and the like can be used. These may be used alone or in combination of two or more.

Various additives may be added to the electrolyte as needed. For example, unsaturated carbonate such as vinylene carbonate, vinylethylene carbonate, or divinylethylene carbonate may be added as an additive that forms a lithium ion conductive film on the surface of the negative electrode.

### Working Examples

The following will describe the present invention more specifically based on working examples, but the present invention is not limited to the working examples.

### Working Example 1

### (1) Positive Electrode Manufacturing

Aluminum foil (a positive electrode current collector) with a thickness of 30 μm was prepared. On the other hand, a positive electrode mixture slurry was prepared by dispersing 88 parts by mass of activated carbon (average particle diameter of 5.5 μm), which is the positive electrode active material, 6 parts by mass of polytetrafluoroethylene, which is the binding material, and 6 parts by mass of acetylene black, which is the conductive material, in water. The obtained positive electrode mixture slurry was applied to both sides of the aluminum foil, and the applied film was dried and rolled to form a positive electrode material layer, thereby obtaining a positive electrode. A 10 mm wide portion from which the positive electrode current collector is exposed was formed at an end of the positive electrode current collector along the longitudinal direction.

### (2) Negative Electrode Manufacturing

Copper foil (negative electrode current collector) with a thickness of 10 μm was prepared. On the other hand, a negative electrode mixture slurry was prepared by dispersing 97 parts by mass of non-graphitizable carbon (average particle diameter of 5 μm), 1 part by mass of carboxycellulose, and 2 parts by mass of styrene butadiene rubber, in water. The obtained negative electrode mixture slurry was applied to both sides of the copper foil, and the applied film was dried and rolled to form a negative electrode material layer, thereby obtaining a negative electrode.

Then, a thin film of metallic lithium for pre-doping was formed on the entire surface of the negative electrode material layer by vacuum vapor deposition. The amount of lithium for use in pre-doping was set so that the negative electrode potential with respect to the metallic lithium in the non-aqueous electrolyte after completion of the pre-doping was 0.2 V or less.

Then, the chamber of the apparatus was purged with carbon dioxide to create a carbon dioxide atmosphere, and a film (second layer) containing lithium carbonate was formed on the surface layer portion of the negative-electrode mixture layer. The dew-point temperature of the carbon dioxide atmosphere was −40° C., the mole fraction of carbon dioxide was 100%, and the pressure in the chamber was 1 atmospheric pressure (1.01×10⁵ Pa). The temperature of the negative electrode exposed to the carbon dioxide atmosphere of 1 atmospheric pressure was 25° C. The time period for which the negative electrode was exposed to the carbon dioxide atmosphere was set to 22 hours.

### (3) Electrode Assembly Manufacturing

A separator of a microporous membrane made of polyolefin was prepared. The separator of a three-layer structure in which both sides of a polyethylene (PE) sheet were coated with polypropylene (PP). The thickness of the PE layer was 8.5 μm, the total thickness of the two sides of the PP layer was 11.5 μm, and the total thickness of the separator was 20 μm. The air permeability resistance of the separator was 200 sec/100 mL.

An electrode assembly was formed by winding the positive electrode and the negative electrode into a columnar shape via the separator. At that time, the core material exposed portions for positive electrodes protruded from one end face of the wound body, and the core material exposed portions for negative electrodes protruded from the other end face of the electrode assembly. Disk-shaped positive electrode current collecting plate and the negative electrode current collecting plate were respectively welded to the core material exposed portions for positive electrodes and the core material exposed portions for negative electrodes.

### (4) Preparation of Non-Aqueous Electrolyte

0.2% by mass of vinylene carbonate was added to a mixture of propylene carbonate and dimethyl carbonate in a volume ratio of 1:1 to prepare a solvent. LiFSI serving as lithium salt was dissolved in the obtained solvent at a concentration of 1.2 mol/L, so that a non-aqueous electrolyte was prepared.

### (5) Assembling of Electrochemical Device

The electrode assembly was housed in a bottomed cell case having an opening, a tab lead connected to the positive electrode current collecting plate was connected to the inner surface of the sealing plate, and the negative electrode current collecting plate was welded to the inner bottom of the cell case. After the non-aqueous electrolyte was placed in the cell case, the opening of the cell case was closed by the sealing plate, and an electrochemical device A1 as shown in FIG. 1 was assembled.

Then, aging was performed at 60° C. while applying a charging voltage of 3.8V between the terminals of the positive electrode and the negative electrode, and pre-doping of lithium ions to the negative electrode was completed.

### (6) Evaluation

### Evaluation 1

### (Measurement of Internal Resistance of Electrochemical Device)

The electrochemical device immediately after the aging was subjected to a constant-current charge at a current density of 2 mA/cm² per positive electrode area under the environment of −30° C. until the voltage reached 3.8 V, and then was brought into a state in which a voltage of 3.8 V was being applied for 10 minutes. Then, the electrochemical device was subjected to a constant-current discharge at a current density of 2 mA/cm² per positive electrode area under the environment of −30° C. until the voltage reached 2.2 V.

Using the discharge curve (where the vertical axis is a discharge voltage, and the horizontal axis is discharge time) obtained from the above-described discharge, the first-order approximate straight line in the range of 0.5 seconds to 2 seconds after the start of discharge in the discharge curve was obtained, and the voltage VS of the intercept of the approximate straight line was obtained. The value obtained by subtracting the voltage VS from the voltage V0 at the start of discharge (0 seconds after the start of discharge) (V0-VS) was calculated as ΔV. Using ΔV(V) and the current value (current density per positive electrode area of 2 mA/cm²×the positive electrode area) Id during the discharge, the internal resistance (DCR) R1 (Ω) of the electrochemical device was obtained from the following expression (A).

$$\\ \begin{matrix}Internal resistance R 1 = Δ V / Id & ( A )\end{matrix}$$

### Evaluation 2

### (Reliability Evaluation of Electrochemical Device)

Then, the electrochemical device was maintained in a state in which a constant voltage of 3.8 V was applied to the electrochemical device under the environment of 85° C., for a prolonged period of time. After every 150 hours, the electrochemical device was taken out and placed in the environment of −30° C. The internal resistance (DCR) R2 (Ω) of the electrochemical device was obtained using the same method as in Evaluation 1. The application of the constant voltage of 3.8 V at 85° C. was continued until the internal resistance R2 of the electrochemical device increased to a resistance that is 1.3 times or more as large as the internal resistance R1. The cumulative application time (high temperature holding time) T, for which the constant voltage of 3.8 V was applied at 85° C. until the internal resistance R2 increased to a resistance 1.3 times or more as large as that of R1, was obtained as the time for which a certain level of reliability was maintained. The longer the cumulative application time T was, the more the increase in internal resistance was suppressed and the higher the reliability was.

### Working Examples 2 to 9

In the manufacturing of the electrode assembly, the material, thickness, and air permeability resistance of the separator were changed as shown in Table 1. Otherwise, electrochemical devices A2 to A9 were manufactured in the same manner as in Working Example 1 and evaluated in the same manner.

In Working Examples 2 and 3, similar to Working Example 1, the separator of a three-layer structure in which both sides of a polyethylene (PE) sheet were coated with polypropylene (PP) was used. The thickness of the PE layer was 7 μm, the total thickness of the two sides of the PP layer was 9 μm, and the total thickness of the separator was 16 μm. The air permeability resistance of the separator was 300 sec/100 mL in Working Example 2 and 500 sec/100 mL in Working Example 3.

In Working Examples 4-9, a single-layer structure separator of microporous membrane made of polypropylene (PP) was used, but the thickness and air permeability resistance of the separator were changed as shown in Table 1.

### Comparative Example 1

In the manufacturing of the electrode assembly, a nonwoven fabric separator made of cellulose was prepared. Otherwise, an electrochemical device B1 was manufactured in the same manner as in Working Example 1 and evaluated in the same manner. The thickness of the nonwoven fabric separator made of cellulose was 25 μm, and the air permeability resistance was 5 sec/100 mL.

### Comparative Example 2

In the manufacturing of the negative electrode, copper foil (negative electrode current collector) having a thickness of 10 μm was prepared, and the negative electrode material layer was formed in the same manner as in Working Example 1, thereby obtaining a negative electrode.

Then, metallic lithium foil was adhered to part of the negative electrode material layer, instead a metallic lithium thin film being formed by vacuum vapor deposition. The amount of metallic lithium foil was determined so that the negative electrode potential with respect to the metallic lithium in the non-aqueous electrolyte after completion of the pre-doping was 0.2 V or less. The positive electrode, and the negative electrode to which the metallic lithium foil was attached were wound into a columnar shape via the nonwoven fabric separator made of cellulose so as to form the electrode assembly. The thickness of the nonwoven fabric separator made of cellulose was 25 μm, and the air permeability resistance was 5 sec/100 mL.

An electrochemical device B2 was manufactured in the same manner as in Working Example 1, and evaluated in the same manner.

Table 1 shows results of the evaluation of the internal resistance (low temperature DCR) and the reliability of the electrochemical devices A1 to A9, B1, and B2. Table 1 shows values of the internal resistances R1 and the cumulative application time T for the devices, together with the characteristics (material, thickness, and permeability resistance) of the separator. In Table 1, the internal resistance R1 and the cumulative application time T are indicated as relative values when the results of electrochemical device A7 were set as 100. The electrochemical devices A1 to A9 correspond to Working Examples 1 to 9, respectively, and the electrochemical devices B1 and B2 correspond to Comparative Examples 1 and 2, respectively.

TABLE 1

| | Separator | | | | |
|---|---|---|---|---|---|
| | | | Air | | |
| Electro- | | | permeability | Internal | Cumulative |
| chemical | | Thickness | resistance | resistance | application |
| device | Material | (μm) | (sec/100 mL) | R1 | time T |
| A1 | PP/PE/PP | 20 | 200 | 114 | 98 |
| A2 | PP/PE/PP | 16 | 300 | 113 | 98 |
| A3 | PP/PE/PP | 16 | 500 | 130 | 96 |
| A4 | PP | 30 | 300 | 140 | 100 |
| A5 | PP | 25 | 200 | 125 | 100 |
| A6 | PP | 16 | 230 | 106 | 101 |
| A7 | PP | 16 | 140 | 100 | 100 |
| A8 | PP | 14 | 180 | 97 | 98 |
| A9 | PP | 12 | 70 | 90 | 95 |
| B1 | cellulose | 25 | 5 | 141 | 60 |
| B2 | cellulose | 25 | 5 | 162 | 95 |

As shown in Table 1, in the devices B1 and B2 that used the separators made of cellulose, the internal resistances R1 are large. However, the internal resistance R1 of electrochemical device B1 is lower than the internal resistance R1 of the electrochemical device B2. The reason for this may be that the electrochemical device B2 contains a large amount of lithium carbonate in the surface layer of the film region, and thus the SEI film is easily broken down, whereas the electrochemical device B1 has a reduced content ratio of lithium carbonate in the surface layer of the film region but has a large amount of lithium fluoride in the surface layer of the film region, which results in formation of a SEI film stable against electrolyte. The reason may also include, because a low-resistance film containing a large amount of lithium carbonate is formed inside the film region, and a film containing a large amount of lithium fluoride is formed so as to cover the low-resistance film, the resistance to lithium ion movement was reduced.

On the other hand, comparing the cumulative application time T, the cumulative application time T of the electrochemical device B1 is longer than the cumulative application time T of the electrochemical device B2, resulting in lower reliability. The reason for this may be that in the electrochemical device B1, pre-doping of lithium ions advanced in a state where a film of metallic lithium was formed over the entire negative electrode material layer, and the metallic lithium reacted with cellulose, which facilitated the deterioration of the separator.

In contrast, in the devices A1 to A9, an olefin-based separators were used to suppress the degradation of the separators and increase the cumulative application time T, resulting in an improvement in reliability. Also, a further reduction in the internal resistance R1 was observed.

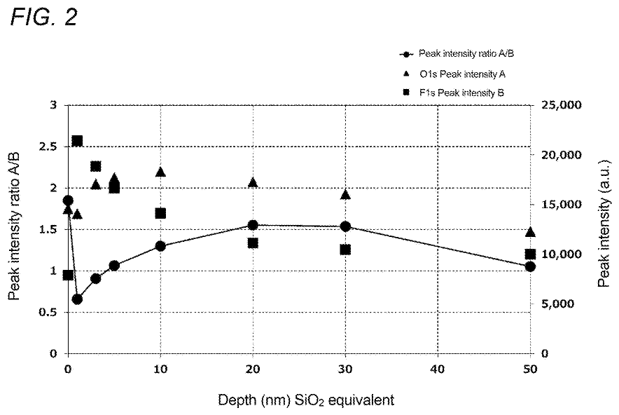

FIG. 2 shows a graph of XPS analysis performed on the surface layer portion of the negative electrode material layer with the second layer containing lithium carbonate and the first layer covering the second layer, and analyzed for C1s spectrum, O1s spectrum, and F1s spectrum. FIG. 2 shows an example of the results of the analysis conducted on the negative electrode taken out from the electrochemical device manufactured by the method shown in Comparative Example 1. Since the manufacturing method of the negative electrode and the composition of the electrolyte are the same among Working Examples 1 to 9 and Comparative Example 1, it is conceivable that the same results as in FIG. 2 can be obtained when the negative electrodes of the electrochemical devices A1 to A9 and B1 are extracted and are subjected to XPS analysis.

Note that an X-ray photoelectron spectrometer (product name: PHI QuanteraSXM, manufactured by ULVAC Phi Inc.) was used for the analysis. The measurement conditions are given below:
X-ray source: Al-mono (1486.6 eV) 15 kV/25 W
Measurement diameter: 100 μmφ
Photoelectron takeoff angle: 45°
Etching conditions: acceleration voltage of 2 kV, etching rate: about 7.05 nm/min (SiO₂ equivalent), raster area 2 mm×2 mm.

In the XPS analysis, from the O1s spectrum, the peak intensity A at the top of the peak appearing in the binding energy range of 530 to 534 eV was determined as the intensity of the peak attributed to the binding of lithium carbonate. Also, from the F1s spectrum, the peak intensity B at the top of the peak appearing in the binding energy range of 684.8 to 685.3 eV was determined as the intensity of the peak attributed to the binding of lithium fluoride. While etching the surface layer portion of the negative electrode material layer, changes in peak intensity A, peak intensity B, and the peak intensity ratio A/B in the depth direction (thickness direction of the surface layer portion) were measured.

Referring to FIG. 2, in the electrochemical device A1 of Working Example 1, the peak intensity A (mark of black triangle) in FIG. 2) attributed to the binding of lithium carbonate in the O1s spectrum increases from the surface layer of the film region toward the inner side (negative electrode active material side), and decreases after reaching a maximum value at a depth of 10 nm in terms of SiO₂ equivalent. On the other hand, the peak intensity B (mark of black square) in FIG. 2) attributed to the binding of lithium fluoride in the F1s spectrum decreases from the surface layer of the film region toward the inner side (negative electrode active material side). This means that the SEI film is formed so that the film (first layer) containing a large amount of lithium fluoride covers the film (second layer) containing a large amount of lithium carbonate. The peak intensity ratio A/B (mark of black circle) in FIG. 2) is about 1.55 and reaches the maximum value at a depth of about 20 nm in terms of SiO₂ equivalent.

In the example in FIG. 2, in the Cis spectrum, the thickness of the SEI film was evaluated to be 50 nm in terms of SiO₂ equivalent as a result of observing a peak derived from the carbon material, which is the negative electrode active material.

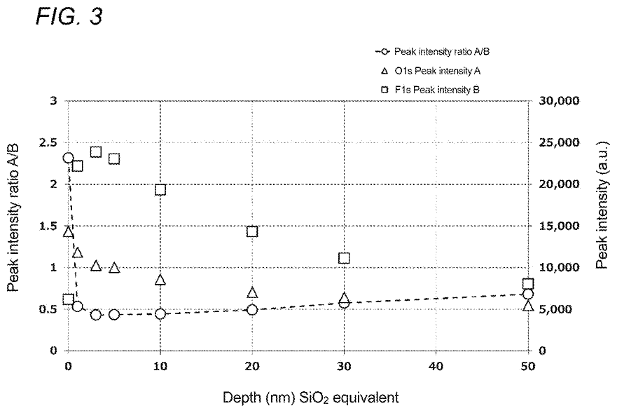

In contrast, FIG. 3 shows a graph of XPS analysis performed on the surface layer portion of the negative electrode material layer in which the second layer containing lithium carbonate is not covered by the first layer, and analyzed for C1s spectrum, O1s spectrum, and F1s spectrum. FIG. 3 shows an example of the results of the analysis conducted on the negative electrode taken out from the electrochemical device manufactured by the method shown in Comparative Example 2. Therefore, it is conceivable that the same results as in FIG. 3 can be obtained when the negative electrodes of the electrochemical device B2 is extracted and is subjected to XPS analysis. Similar to FIG. 2, FIG. 3 shows changes in peak intensity A, peak intensity B, and the peak intensity ratio A/B in the depth direction.

Referring to FIG. 3, in the electrochemical device B1 of Comparative Example 1, the peak intensity A (mark of white triangle) in FIG. 3) attributed to the binding of lithium carbonate in the O1s spectrum decreases from the surface layer of the film region toward the inner side (negative electrode active material side). On the other hand, in the F1s spectrum, the peak intensity B attributed to the binding of lithium fluoride (mark of white square) in FIG. 3) increases and then decreases from the surface layer of the film region toward the inner side (negative electrode active material side). This means that the SEI film containing a large amount of lithium carbonate was formed on the surface layer of the film region, and the film containing a large amount of lithium carbonate was formed without being covered by the film containing a large amount of lithium fluoride. No maximum value was observed in the peak intensity ratio A/B (mark of white circles) in FIG. 3) due to changes in the depth direction.

In the example in FIG. 3, in the Cis spectrum, the thickness of the SEI film was evaluated to be 20 nm in terms of SiO₂ equivalent as a result of observing a peak derived from the carbon material, which is the negative electrode active material.

### INDUSTRIAL APPLICABILITY

The electrochemical device according to the present invention is appropriate for use in vehicle installation, for example.

### REFERENCE SIGNS LIST

100: Electrode assembly
10: Positive electrode
11x: Core material exposed portion for positive electrode
13: Positive electrode current collecting plate
15: Tab lead
20: Negative electrode
21x: Core material exposed portion for negative electrode
23: Negative electrode current collecting plate
30: Separator
200: Electrochemical device
210: Cell case
220: Sealing plate
221: Gasket

1. An electrochemical device comprising: a positive electrode; a negative electrode; a separator; and a lithium ion-conductive electrolyte,
wherein the negative electrode includes a negative electrode current collector, and a negative electrode material layer supported on the negative electrode current collector,
the negative electrode material layer includes a negative electrode active material into which lithium ions are reversibly doped,
the negative electrode includes a carbon material,
a surface layer portion of the negative electrode material layer has a film region,
the separator includes an olefin-based resin,
when the film region is measured by X-ray photoelectron spectroscopy, a peak in an O1s spectrum is observed in a binding energy range of 530 to 534 eV, and
an intensity of the peak in the O1s spectrum increases from a surface layer of the film region toward an inner side.

2. The electrochemical device according to claim 1,
wherein the separator has a thickness of 12 μm or more and 30 μm or less, and
the separator has an air permeability resistance A of 70 sec/100 mL or more and 500 sec/100 mL or less.

3. The electrochemical device according to claim 1,
wherein the olefin-based resin contains at least one selected from the group consisting of polypropylene and polyethylene.

4. The electrochemical device according to claim 1,
wherein, when the film region is measured by X-ray photoelectron spectroscopy, a peak in an F1s spectrum is observed in a binding energy range of 684.8 to 685.3 eV, and
an intensity of the peak in the F1s spectrum decreases from the surface layer of the film region toward the inner side.

5. The electrochemical device according to claim 4,
wherein a ratio A/B of a peak intensity A at the top of the peak in the O1s spectrum to a peak intensity B at the top of the peak in the F1s spectrum increases and then decreases from the surface layer of the film region toward the inner side.

6. The electrochemical device according to claim 5,
wherein, when the surface layer portion of the negative electrode material layer is measured by X-ray photoelectron spectroscopy, substantially no peak attributed to binding of the carbon material in the C1s spectrum is observed in a depth from the surface layer of the film region at which the ratio A/B is the maximum.

7. The electrochemical device according to claim 1,
wherein the positive electrode includes a positive electrode current collector, and a positive electrode material layer supported on the positive electrode current collector, and
the positive electrode material layer contains a carbon material serving as a positive electrode active material, and constitutes a polarizable electrode layer.
